(19) United States
(12) Patent Application Publication
(10) Pub. No.: US 2020/0168918 A1
(43) Pub. Date: May 28, 2020

(54) METHOD FOR PRODUCING A FUEL CELL AND A FUEL CELL

(71) Applicant: Robert Bosch GmbH, Stuttgart (DE)

(72) Inventor: Ulrich Berner, Stuttgart (DE)

(21) Appl. No.: 16/618,535

(22) PCT Filed: May 7, 2018
(86) PCT No.: PCT/EP2018/061645

§ 371 Date: Dec. 2, 2019

(30) Foreign Application Priority Data
May 30, 2017 (DE) 10 2017 209 031.6

(51) Int. Cl. H01M 8/0258; H01M 8/0206

(52) U.S. Cl. CPC H01M 8/0258; H01M 8/0206

(57) ABSTRACT

The invention relates to a method for producing a fuel cell, which has at least one membrane-electrode assembly having a first electrode and a second electrode, which are separated from one another by a membrane, and at least one bipolar plate, which comprises a first distribution area for distributing a fuel to the first electrode and a second distribution area for distributing an oxidizing agent to the second electrode, said method comprising the following steps: a) generating a flat fabric (80); b) passing the fabric (80) between two rolls (90), which each have a structured surface (93), as a result of which the fabric (80) is deformed in such a manner that humps (32) are created in the fabric (80); c) arranging the distribution unit (30) created in this way in at least one distribution area of the at least one bipolar plate. The invention further relates to a fuel cell produced by the method according to the invention.

### BACKGROUND OF THE INVENTION

The invention relates to a method for producing a fuel cell which has at least one membrane-electrode unit having a first electrode and a second electrode which are mutually separated by a membrane, and at least one bipolar plate which comprises a first distribution region for distributing a fuel to the first electrode and a second distribution region for distributing an oxidant to the second electrode. The invention also relates to a fuel cell produced by the method according to the invention.

A fuel cell is a galvanic cell which converts the chemical reaction energy of a continuously supplied fuel and of an oxidant to electric energy. A fuel cell is thus an electro-chemical energy converter. In the case of known fuel cells, hydrogen (H₂) and oxygen (O₂) are in particular converted to water (H₂O), electric energy, and heat.

Proton-exchange membrane (PEM) fuel cells are inter-alia known. Proton-exchange membrane fuel cells have a centrally disposed membrane which is permeable to protons, thus to hydrogen ions. On account thereof, the oxidant, in particular atmospheric oxygen, is spatially separated from the fuel, in particular hydrogen.

Proton-exchange membrane fuel cells furthermore have an anode and a cathode. The fuel is supplied to the fuel cell at the anode and is catalytically oxidized so as to form protons while discharging electrodes. The protons make their way through the membrane to the cathode. The discharged electrons are directed out of the fuel cell and by way of an external current circuit flow to the cathode.

The oxidant is supplied to the fuel cell at the cathode and reacts so as to form water by absorbing the electrons from the external current circuit and protons which have made their way through the membrane to the cathode. The water thus created is directed from the fuel cell. The gross reaction is:

O₂+4H⁺+4e⁻→2H₂O

A voltage exists herein between the anode and the cathode of the fuel cell. In order for the voltage be increased, a plurality of fuel cells can be disposed behind one another in mechanical terms to form a stack of fuel cells and be switched in series in electrical terms.

Bipolar plates are provided for the uniform distribution of the fuel to the anode as well as for the uniform distribution of the oxidant to the cathode. For example, the bipolar plates have channel-type structures for distributing the fuel as well as the oxidant to the electrodes. The channel-type structures furthermore serve for directing away the water created in the reaction. The bipolar plates can furthermore have structures for directing a cooling liquid through the fuel cells in order for heat to be dissipated.

A fuel cell having a bipolar plate which is constructed from two plate halves is known from DE 10 2012 221 730 A1. Each of the two plate halves herein has a distribution region which is provided for distributing the reaction gases.

### SUMMARY OF THE INVENTION

A method for producing a fuel cell is proposed. The fuel cell herein has at least one membrane-electrode unit having a first electrode and a second electrode which are mutually separated by a membrane, and at least one bipolar plate which comprises a first distribution region for distributing a fuel to the first electrode and a second distribution region for distributing an oxidant to the second electrode. The method herein comprises a plurality of steps which will be explained hereunder.

In a step a) a flat woven fabric is generated. A woven fabric in the context of the present invention is to be understood to be a structure which is formed from interwoven wires, threads, or fibers. The woven fabric herein is configured so as to be comparatively flat. The woven fabric in one face first thus extends significantly farther than in a direction which is perpendicular to said face.

In a step b) the woven fabric is guided between two rollers which have in each case a structured surface. The woven fabric herein is deformed by the rollers, the woven fabric being deformed in particular in that elevations of the woven fabric are created. The woven fabric which now has the elevations forms a distribution unit.

In a step c) the distribution unit thus created is disposed in at least one distribution region of the at least one bipolar plate. The distribution unit is preferably disposed in the second distribution region which serves for distributing the oxidant to the second electrode as well as for directing away water created in the reaction. Alternatively or additionally however, the distribution unit can also be disposed in the first distribution region in order for a fuel to be distributed to the first electrode.

The two rollers between which the woven fabric is guided rotate in each case about a rotation axis, wherein the rotation axes of the two rollers run so as to be mutually parallel. The two rollers herein rotate at identical rotating speeds in opposite directions. The two rollers rotate in particular in such a manner that the structured surfaces in a region in which the woven fabric is guided through move in the same transporting direction as the woven fabric.

The two rollers are preferably approximately circular-cylindrical and thus configured so as to be rotationally symmetrical in relation to the rotation axes of said rollers. The direction which extends along the rotation axis will be referred to hereunder as the axial direction. A direction which extends from the rotation axis outward toward the surface will be referred to hereunder as the radial direction. The direction which extends tangentially along the surface will be referred to hereunder as the circumferential direction. The radial direction herein is oriented so as to be orthogonal to the axial direction and orthogonal to the circumferential direction.

According to one preferred design embodiment of the invention, the structured surfaces of the two rollers have protrusions. A protrusion in this context is to be understood as a locally delimited expansion in the radial direction.

According to one advantageous refinement of the invention, said protrusions of the structured surfaces of the two rollers run so as to be rectilinear in the axial direction.

According to one other advantageous refinement of the invention, said protrusions of the structured surfaces of the two rollers run so as to be inclined in a rectilinear manner to the axial direction and inclined to the circumferential direction.

According to one further advantageous refinement of the invention, said protrusions of the structured surfaces of the two rollers run in the circumferential direction so as to be pendular in the axial direction. In simple terms, the protrusions of the structured surfaces of the two rollers run in sinuous lines, or in a zigzag manner, respectively.

The woven fabric from which the distribution unit is formed is advantageously configured so as to be porous and electrically conductive. The distribution unit is thus permeable to the oxidant as well as to the fuel and also to water be directed away. Furthermore, the distribution unit establishes an electrically conductive connection to the electrode. The distribution unit can thus direct the electrons that are released in the electro-chemical reaction in the fuel cell.

The woven fabric from which the distribution unit is formed advantageously has at least one metal-containing fiber. The metal-containing fiber ensures in particular the electrical conductivity of the distribution unit. Potential materials which are suitable for the metal-containing fiber are, for example, titanium, copper, nickel, aluminum, stainless steel.

The woven fabric from which the distribution unit is formed advantageously has at least one carbon-containing fiber. The carbon-containing fiber is particularly corrosion-resistant and additionally increases the required mechanical stability of the distribution unit.

The woven fabric from which the distribution unit is formed advantageously has at least one plastics-containing fiber. The plastics-containing fiber is comparatively light in comparison to fibers from other materials and thus reduces the weight of the distribution unit. The plastics-containing fiber is furthermore cost-effective and corrosion-resistant.

According to one advantageous refinement of the invention, the woven fabric from which the distribution unit is formed has at least two different types of fibers. Advantageous properties of the distribution unit can thus be optimized in a manner specific to the application. A fiber in this context is also to be understood to be a wire or a thread.

According to one preferred design embodiment of the invention, the distribution unit is disposed in the distribution the region of the bipolar plate in such a manner that the elevations of the woven fabric physically contact one of the electrodes. When the distribution unit is disposed in the second distribution region which serves for distributing the oxidant as well as for directing away water created in the reaction, the elevations thus physically contact the second electrode. When the distribution unit is disposed in the first distribution region for distributing a fuel, the elevations thus physically contact the first electrode.

A fuel cell which is produced by the method according to the invention is also proposed. The fuel cell is in particular constructed in such a manner that in each case one bipolar plate adjoins the membrane-electrode unit on either side, wherein a distribution unit is disposed in at least one distribution region of the bipolar plates.

Structures for distributing the reaction gas can be configured in a targeted manner in a distribution region of the bipolar plate by means of the distribution unit which is formed from a woven fabric having elevations. Woven fabrics can be produced in a very simple and cost-effective manner, in particular in comparison to foams. Only a comparatively minor pressure loss is created in the bipolar plate when the distribution unit is passed through by a flow of gas, in particular the fuel or the oxidant. The deformation of the flat woven fabric by means of the rollers having structured surfaces herein is particularly simple and cost-effective as compared to other forming techniques such as, for example, embossing. The woven fabric can in particular be continuously guided through between the rollers. The woven fabric herein is not held under tension, as in the case of embossing, for example, and the deformations can be achieved by drawing-in further woven fabric. The choice in terms of potential geometries herein is thus significantly increased as compared to embossing. The shape and the size of the elevations can be further adapted by varying the mutual spacing of the rotation axes of the two rollers.

### BRIEF DESCRIPTION OF THE DRAWINGS

Embodiments of the invention will be explained in more detail by means of the drawings and the description hereunder:

In the figures:

FIG. 1 shows a schematic illustration of a fuel cell stack having a plurality of fuel cells;

FIG. 2 shows a schematic illustration of the production of a distribution unit;

FIG. 3 shows a perspective illustration of a roller according to a first variant;

FIG. 4 shows a perspective illustration of a distribution unit according to a first variant;

FIG. 5 shows a perspective illustration of a roller according to a second variant;

FIG. 6 shows a perspective illustration of a distribution unit according to a second variant;

FIG. 7 shows a perspective illustration of a roller according to a third variant;

FIG. 8 shows a perspective illustration of a distribution unit according to a third variant; and

FIG. 9 shows a section through a bipolar plate of the fuel cell stack from FIG. 1.

### DETAILED DESCRIPTION

Identical or similar elements are identified with the same reference sign in the description hereunder of the embodiments of the invention, wherein a repetition of the description of said elements is dispensed with in individual cases. The figures illustrate the subject matter of the invention in only a schematic manner.

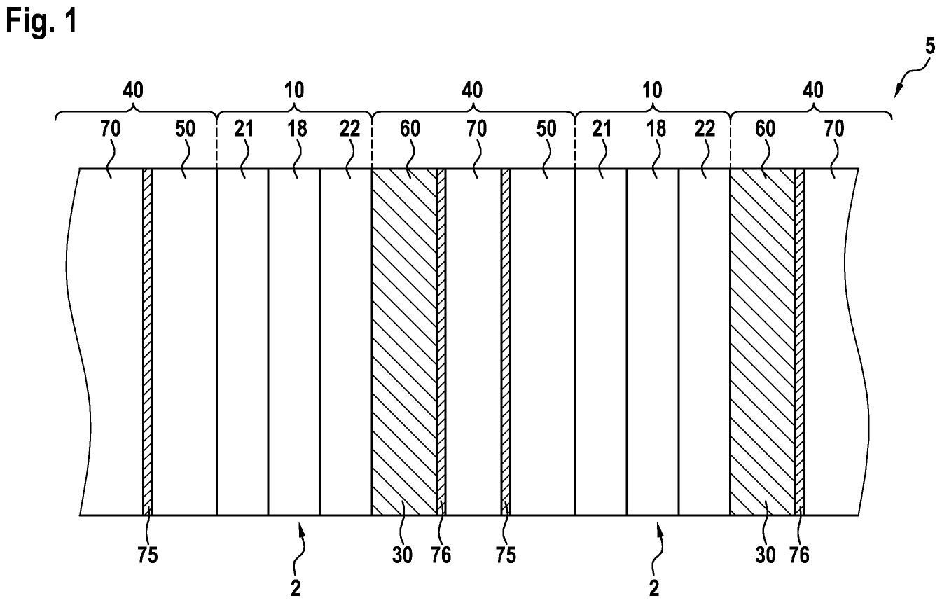

FIG. 1 shows a schematic illustration of a fuel cell stack 5 having a plurality of fuel cells 2. Each fuel cell 2 has one membrane-electrode unit 10 which comprises a first electrode 21, a second electrode 22, and a membrane 18. The two electrodes 21, 22 are disposed on mutually opposite sides of the membrane 18 and are thus mutually separated by the membrane 18. The first electrode 21 hereunder will also be referred to as the anode 21, and the second electrode 22 hereunder will also be referred to as the cathode 22. The membrane 18 is configured as a polymer electrolyte membrane. The membrane 18 is permeable to hydrogen ions, thus H⁺ ions.

Each fuel cell 2 furthermore has two bipolar plates 40 which adjoin the membrane-electrode unit 10 on either side. In the disposal of a plurality of fuel cells 2 in the fuel cell stack 5 shown here, each of the bipolar plates 40 can be considered as being associated with two fuel cells 2 that are disposed so as to be mutually adjacent.

The bipolar plates 40 comprise in each case one first distribution region 50 for distributing a fuel, said first distribution region 50 facing the anode 21. The bipolar plates 40 also comprise in each case one second distribution region 60 for distributing the oxidant, said second distribution region 60 facing the cathode 22. The second distribution region 60 simultaneously serves for directing away water created in a reaction in the fuel cell 2. A distribution unit 30 is disposed in the second distribution region 60.

The bipolar plates 40 presently comprise a third distribution region 70 which is disposed between the first distribution region 50 and the second distribution region 60. The third distribution region 70 serves for directing a coolant through the bipolar plates 40 and thus for cooling the fuel cell 2 and the fuel cell stack 5.

The first distribution region 50 and the third distribution region 70 are mutually separated by a first separation plate 75. The second distribution region 60 and the third distribution region 70 are mutually separated by a second separation plate 76. The separation plates 75, 76 of the bipolar plates 40 are presently configured as thin metallic sheets.

In the operation of the fuel cell 2, fuel is directed by way of the first distribution region 50 to the anode 21. Likewise, oxidant is directed by way of the second distribution region 60, having the distribution unit 30, to the cathode 22. The fuel, presently hydrogen, at the anode 21 is catalytically oxidized so as to form protons, thus hydrogen ions, while discharging electrons. The protons make their way through the membrane 18 to the cathode 22. The discharged electrons are directed out of the fuel cell 2 and by way of an external current circuit flow to the cathode 22. The oxidant, presently atmospheric oxygen, on account of absorbing the electrons from the external current circuit and protons which have made the way through the membrane 18 into the cathode 22, reacts so as to form water.

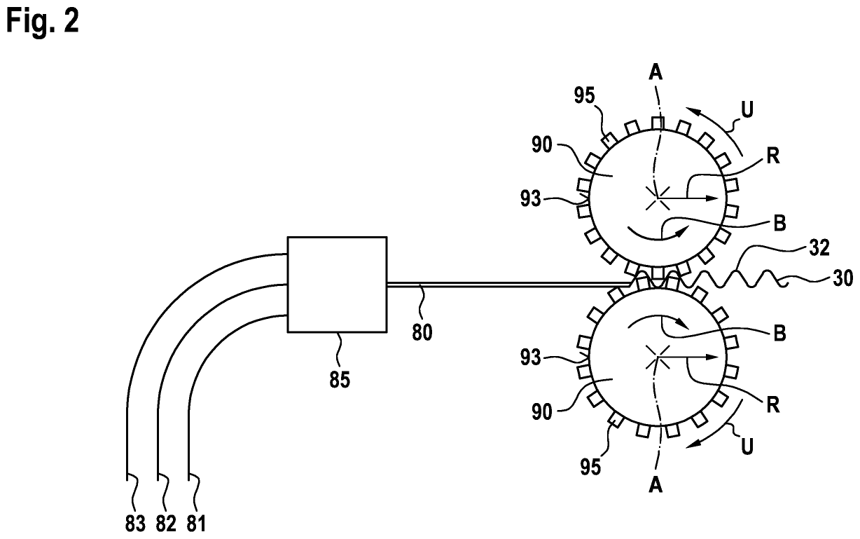

FIG. 2 shows a schematic illustration of the production of a distribution unit 30. A metal-containing fiber 81, a carbon-containing fiber 82, and a plastics-containing fiber 83 are supplied to a weaving device 85. A flat woven fabric 80 is generated in the weaving device 85 by weaving the metal-containing fiber 81, the carbon-containing fiber 82, and the plastics-containing fiber 83.

The flat woven fabric 80 is guided through between two rollers 90 which have in each case a structured surface 93. The two rollers 90 rotate in each case about a rotation axis A, wherein the rotation axes A of the two rollers 90 run so as to be mutually parallel. The two rollers 90 rotate at identical rotating speeds in opposite directions, as is indicated by the two directional arrows B.

The two rollers 90 are approximately circular-cylindrical and thus configured so as to be approximately rotationally symmetrical in relation to the rotation axis A of said rollers 90. A direction which extends along the rotation axis A will be referred to hereunder as the axial direction X. A direction which extends from the rotation axis A outward towards the surface 93 will be referred to hereunder as the radial direction R. A direction which extends tangentially along the surface 93 will be referred to hereunder as the circumferential direction U. The radial direction R herein is oriented so as to be orthogonal to the axial direction X and orthogonal to the circumferential direction U.

The structured surfaces 93 of the two rollers 90 along the circumferential direction U have protrusions 95. A protrusion 95 in this context is to be understood to be a locally delimited expansion in the radial direction R. When guiding the woven fabric 80 through between the two rollers 90, woven fabric 80 is deformed by the protrusions 95 in such a manner that elevations 32 of the woven fabric 80 are created. The woven fabric 80 which now has the elevations 32 then forms the distribution unit 30.

In a following step, cutting the distribution unit 30 to desired or required, respectively, dimensions is performed. The cutting of the distribution unit 30 to size is performed by means of punching or laser-cutting, for example.

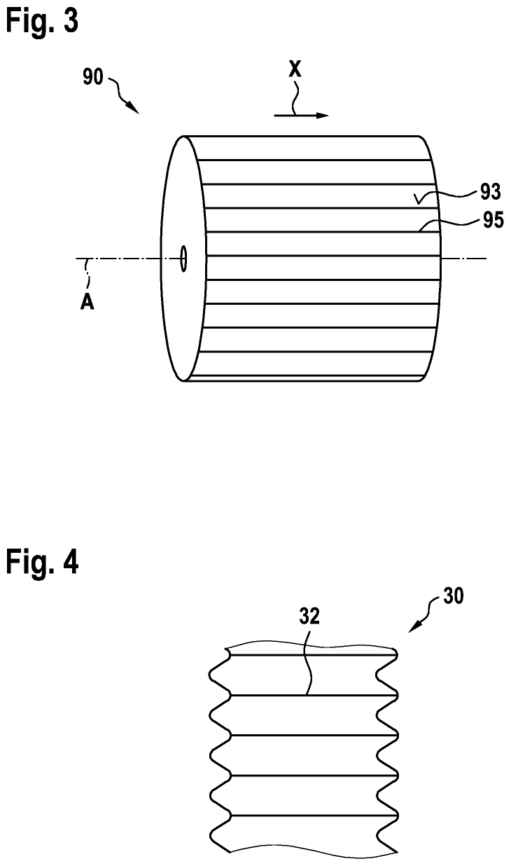

FIG. 3 shows a perspective illustration of a roller 90 according to a first variant. The structured surface 93 of the roller 90 has protrusions 95 which run so as to be rectilinear in the axial direction X.

FIG. 4 shows a perspective illustration of the distribution unit 30 according to a first variant which is produced by means of two rollers 90 according to the first variant. The elevations 32 of the distribution unit 30 run so as to be rectilinear and mutually parallel.

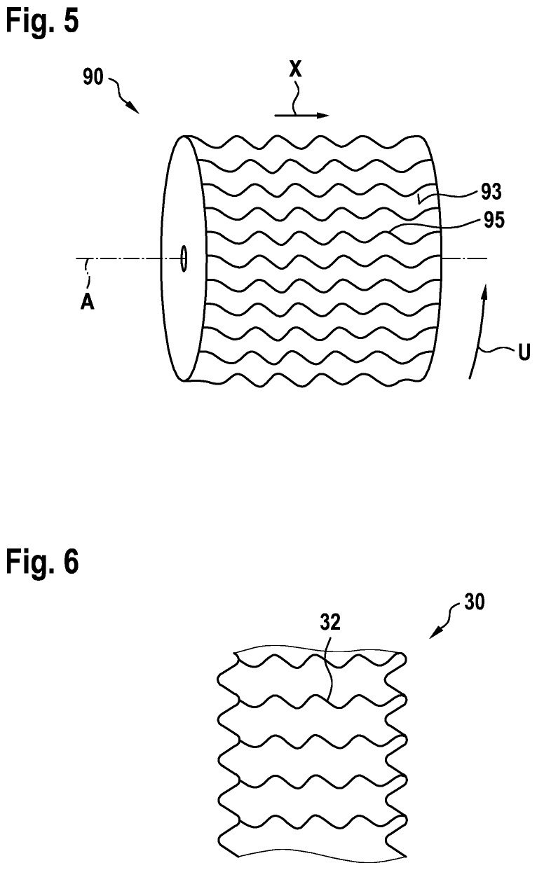

FIG. 5 shows a perspective illustration of a roller 90 according to a second variant. The structured surface 93 of the roller 90 has protrusions 95 which in the circumferential direction U run so as to be pendular in the axial direction X. In simple terms, the protrusions 95 run in sinuous lines or in a zigzag manner on the surface 93.

FIG. 6 shows a perspective illustration of the distribution unit 30 according to a second variant which is produced by means of two rollers 90 according to the second variant. The elevations 32 of the distribution unit 30 run in sinuous lines and so as to be uniformly mutually spaced apart.

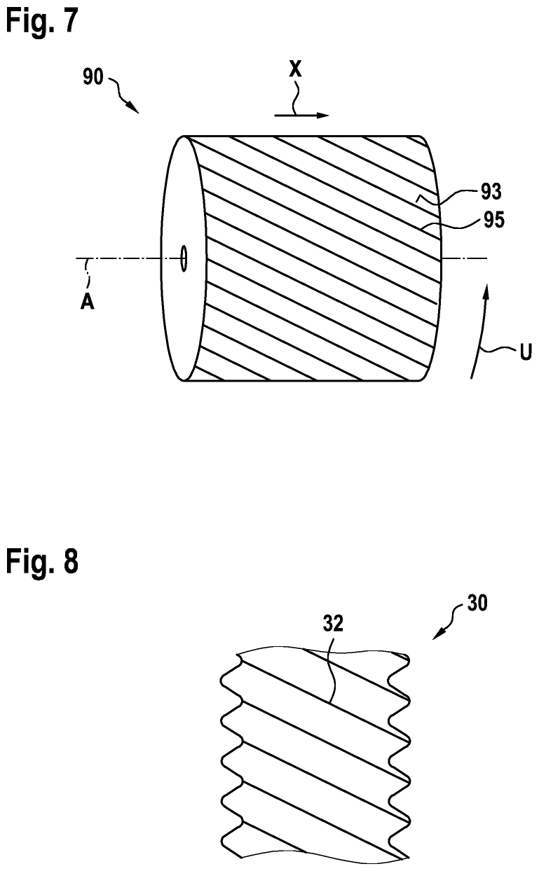

FIG. 7 shows a perspective illustration of a roller 90 according to a third variant. The structured surface 93 of the roller 90 has protrusions 95 which run so as to be inclined in a rectilinear manner to the axial direction X and inclined to the circumferential direction U.

FIG. 8 shows a perspective illustration of a distribution unit 30 according to a third variant which is produced by means of two rollers 90 according to the third variant. The elevations 32 of the distribution unit 30 run so as to be rectilinear and mutually parallel. The elevations 32 of the distribution unit 30 herein run so as to be inclined to the edges that delimit the distribution unit 30.

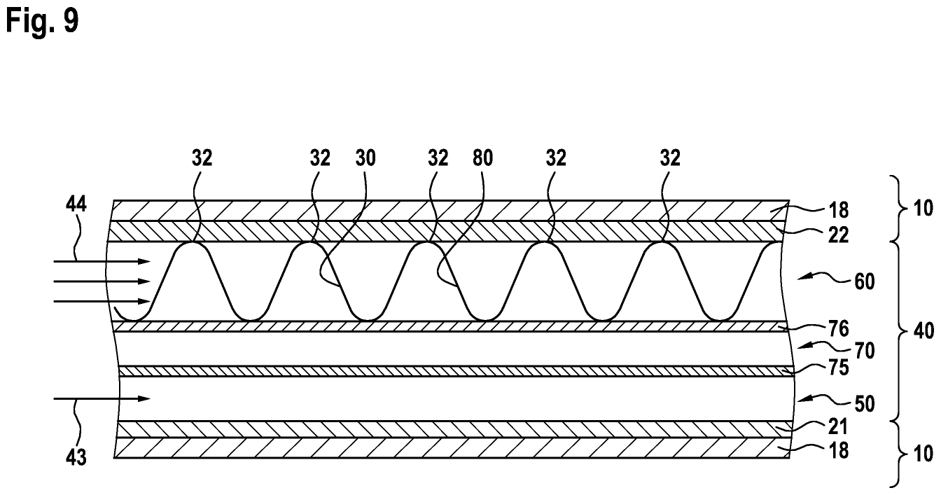

FIG. 9 shows a section through a bipolar plate 40 of the fuel cell stack 5 in FIG. 1, said bipolar plate 40 being disposed between two membrane-electrode units 10. The separation plate 75, 76 are configured as thin metallic plates and there between form the third distribution region 70 for directing the coolant therethrough. The first distribution region 50 is situated between the first separation plate 75 and the anode 21 of the adjacent membrane-electrode unit 10.

The second distribution region 60 in which a distribution unit 30 is disposed is situated between the second separation plate 76 and the cathode 22 of the other adjacent membrane-electrode unit 10. The distribution unit 30 is disposed in such a manner that the elevations 32 of the woven fabric 80 physically contact the cathode 22. The distribution unit 30 furthermore also physically contacts the second separation plate 76.

The fuel, presently hydrogen, is directed in a first flow direction 43 into the first distribution region 50. The oxidant, presently atmospheric oxygen, is directed in a second flow direction 44 into the second distribution region 60. The first flow direction 43 and the second flow direction 44 presently run so as to be mutually parallel. It is also conceivable that the first flow direction 43 and the second flow direction 44 run so as to be mutually opposed or else so as to be mutually orthogonal.

The invention is not limited to the exemplary embodiments described here and the aspects highlighted herein. Rather, a multiplicity of modifications which are within the scope of the activities of a person skilled in the art are possible within the scope stated by way of the claims.

1. A method for producing a fuel cell (2) which has at least one membrane-electrode unit (10) having a first electrode (21) and a second electrode (22) mutually separated by a membrane (18), and at least one bipolar plate (40) which comprises a first distribution region (50) for distributing a fuel to the first electrode (21), and a second distribution region (60) for distributing an oxidant to the second electrode (22), said method comprising the following steps:
a) generating a flat woven fabric (80);
b) guiding the woven fabric (80) between two rollers (90) which have in each case a structured surface (93), on account of which the woven fabric (80) is deformed in such a manner that elevations (32) of the woven fabric (80) are created;
c) disposing a distribution unit (30) thus created in at least one distribution region (50, 60) of the at least one bipolar plate (40).

2. The method as claimed in claim 1, wherein the rollers (90) rotate in each case about one rotation axis (A), said rotation axes (A) running so as to be mutually parallel, and wherein the rollers (90) rotate at identical rotating speeds in opposite directions.

3. The method as claimed in claim 2, wherein the structured surfaces (93) have protrusions (95) which run so as to be rectilinear in an axial direction (X).

4. The method as claimed in claim 2, wherein the structured surfaces (93) have protrusions (95) which run so as to be inclined in a rectilinear manner to an axial direction (X) and inclined to a circumferential direction (U).

5. The method as claimed in claim 2, wherein the structured surfaces (93) have protrusions (95) which in a circumferential direction (U) run so as to be pendular in an axial direction (X).

6. The method as claimed in claim 1, wherein the woven fabric (80) is configured so as to be porous and electrically conductive.

7. The method as claimed in claim 1, wherein the woven fabric (80) has at least one metal-containing fiber (81).

8. The method as claimed in claim 1, wherein the woven fabric (80) is generated from at least two different types of fibers.

9. The method as claimed in claim 1, wherein the distribution unit (30) is disposed in the distribution region (50, 60) in such a manner that the elevations (32) of the woven fabric (80) physically contact one of the electrodes (21, 22).

10. (canceled)
